(19) United States
(12) Patent Application Publication
(10) Pub. No.: US 2004/0034520 A1
(43) Pub. Date: Feb. 19, 2004

(54) Sentence generator

(76) Inventors: Irene Langkilde-Geary, Provo, UT (US); Kevin Knight, Hermosa Beach, CA (US)

Correspondence Address: FISH & RICHARDSON, PC, 12390 EL CAMINO REAL, SAN DIEGO, CA, 92130-2081, US

(21) Appl. No.: 10/382,727

(22) Filed: Mar. 4, 2003

Related U.S. Application Data
(60) Provisional application No. 60/361,757, filed on Mar. 4, 2002.

(51) Int. Cl. G06F 17/20

(52) U.S. Cl. 704/1

(57) ABSTRACT

Systems and techniques for generating language from an input use a symbolic generator and a statistical ranker. The symbolic generator may use a transformation algorithm to transform one or more portions of the input. For example, mapping rules such as morph rules, recasting rules, filling rules, and/or ordering rules may be used. The symbolic generator may output a plurality of possible expressions, while the statistical ranker may rank at least some of the possible expressions to determine the best output.

### CROSS-REFERENCE TO RELATED APPLICATIONS

This application claims priority to U.S. Provisional Application Serial No. 60/361,757, filed Mar. 4, 2002, entitled “HALOGEN STATISTICAL SENTENCE GENERATOR,” which is hereby incorporated by reference.

### STATEMENT OF GOVERNMENT-SPONSORED RESEARCH

This invention was made with Government support under National Science Foundation Award Number 9820291. The Government has certain rights in this invention.

### TECHNICAL FIELD

This invention relates to language generation.

### BACKGROUND

From early computing days, computers have been used to process and generate human language. Early efforts focused on machine translation, while today the use of natural language generation has expanded to encompass a wide variety of applications.

For example, sentence generation may be used to enable human-computer dialogue, summarization, report creation, automatic technical documentation, proof/decision explanation, customized instructions, item and event descriptions, question answering, tutorials, and stories.

A sentence generator may be customized to the application or may be general purpose. General purpose sentence generators may facilitate the reuse of resources and thus reduce the costs of building applications. Examples of general purpose sentence generators include FUF/Surge, RealPro, Penman/KPML, and Nitrogen.

It is difficult for a general purpose sentence generator to achieve high quality output and at the same time to cover a broad range of inputs. Usually, rules and class features implemented with general purpose sentence generators are too general to rule out some undesirable combinations, while at the same time they are too restrictive to allow some valid combinations. Higher quality is generally easier to achieve with smaller-scale applications or in limited domains.

### SUMMARY

In general, in one aspect, a method for generating sentences includes receiving an input representing one or more ideas to be expressed. The method may include transforming at least a portion of the input using a transformation algorithm.

Transforming the input may include transforming at least a portion of the input using a recasting rule, a morph rule, a filling rule, and/or an ordering rule. The rules may transform the same or similar portions of the input.

The method may include producing a plurality of possible expressions for the one or more ideas based on the transforming. The method may include ranking at least some of the plurality of possible expressions, and may include producing an output sentence expressing the one or more ideas based on the ranking.

The method may include processing inputs which may include one or more labeled feature values. The feature type may be a relation feature, a property feature, or other feature type.

In general, in one aspect, a system may include a symbolic generator and a statistical generator. The symbolic generator may receive input representing one or more ideas, process the input, and produce a number of possible expressions based on the processing. The statistical ranker may receive at least some of the possible expressions, may rank at least some of the possible expressions, and may determine the best choice of the possible expressions.

The symbolic generator may process the input according to a transformation algorithm. The transformation algorithm may include one or more mapping rules such as recasting rules, morph rules, filling rules, and ordering rules. The symbolic generator may access a knowledge base, which may include a lexicon such as a closed lexicon and/or an application specific lexicon. The knowledge base may include a dictionary.

The symbolic generator may process minimally specified inputs, fully specified inputs, or inputs with specification between the two. The symbolic generator may assign a weight to a possible choice. The statistical ranker may use the weight to determine the best choice.

The symbolic generator may process inputs with a plurality of nesting levels including a top nesting level and one or more lower nesting levels. The input may have meta OR nodes at a lower nesting level. The symbolic generator may process input having an instance relation with compound values. The symbolic generator may process input including a template relation.

The details of one or more implementations are set forth in the accompanying drawings and the description below. Other features and advantages will be apparent from the description and drawings, and from the claims.

### DESCRIPTION OF DRAWINGS

FIG. 1A is a representation of machine translation.

FIG. 1B is a representation of human-computer dialog.

FIG. 2 shows a system that may be used to generate sentences based on input.

FIG. 3 shows a process that may be used to generate sentences.

FIG. 4A shows a Penn Treebank annotation and associated sentence.

FIG. 4B shows a minimally specified input for the example of FIG. 4A.

FIG. 4C shows an almost fully specified input for the example of FIG. 4A.

FIG. 5 shows an algorithm that may be used to preserve ambiguities.

FIG. 6A shows a recasting rule.

FIG. 6B shows another recasting rule.

FIG. 7 shows a filling rule.

FIG. 8 shows an ordering rule.

FIG. 9 shows a morph rule.

FIG. 10 shows a forest.

FIG. 11A shows another forest.

FIG. 11B shows an internal PF representation of the top three levels of nodes of the forest of FIG. 11A.

FIG. 12 illustrates a pruning process that may be used with a bigram model.

FIG. 13 shows pseudocode that may be used for a ranking algorithm.

Like reference symbols in the various drawings indicate like elements.

### DETAILED DESCRIPTION

The goal of sentence generation is to transform an input into a linearly-ordered, grammatical string of morphologically inflected words; that is, a fluent sentence.

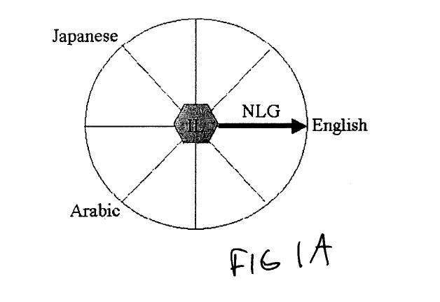

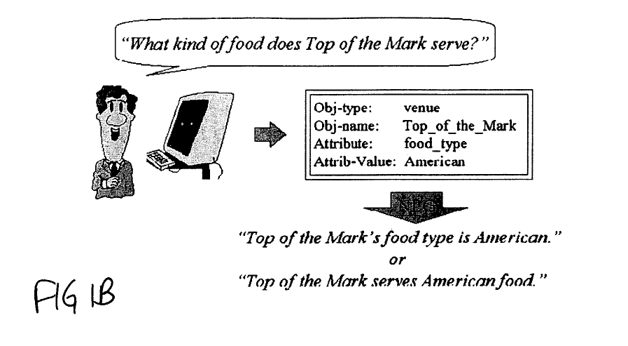

FIG. 1A illustrates a process of sentence generation in a machine translation system. A user may input a sentence in Arabic to be translated into English. The meaning of the sentence is represented by language-neutral terms (referred to generally as interlingua). The language-neutral terms are input to a sentence generator, which produces a translated English sentence. FIG. 1B illustrates a process of sentence generation in the context of a human-computer dialogue application. The input to the sentence generator is, for example, the output of a database.

Systems and techniques described herein may provide a number of benefits over available systems. The system input and mapping rules may be structured so that the system may provide complete coverage of English. Some previous systems limited the coverage in order to reduce the generation of ungrammatical sentences. In the current system, although ungrammatical sentences may be generated as part of the forest of possible expressions, the statistical ranker may be used to reduce the generation of ungrammatical output. Therefore, the current system does much to resolve the conflict between broad coverage and accuracy.

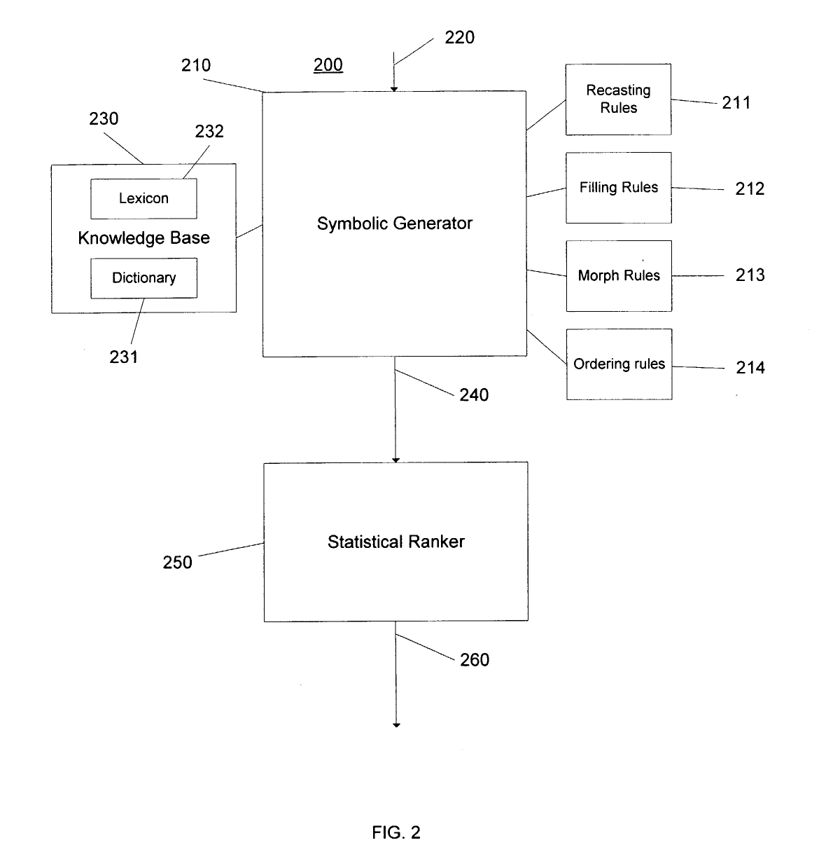

Referring to FIG. 2, a system 200 includes a symbolic generator 210 for receiving input 220 expressing one or more ideas. Symbolic generator 210 may transform one or more portions of the input according to one or more transformation algorithms. Symbolic generator 210 may access, for example, recasting rules 211, filling rules 212, morph rules 213, and ordering rules 214 for processing at least a portion of input 220. Note that rules 211-214 may be integrated with symbolic generator or may be separate.

Symbolic generator 210 may use a knowledge base 230 to map input to one or more possible output expressions 240 (e.g., a forest). Knowledge base 230 may include a dictionary 231 such as a Wordnet-based dictionary, one or more lexicons 232 such as a closed-class lexicon and an application-specific lexicon, and morphological inflection tables. Recasting rules 211, filling rules 212, morph rules 213, and ordering rules 214 may be considered part of knowledge base 230.

Symbolic generator 210 may use an ontology such as the Sensus concept ontology, which is a WordNet-based hierarchy of word meanings segregated into events, objects, qualities, and adverbs. The Sensus concept ontology includes a rank field to order concepts by sense frequency for a given word.

Expression(s) 240 of symbolic generator 210 may be provided to a statistical ranker 250 to choose among expressions 240. Statistical ranker 250 may use an ngram scheme (e.g., a bigram or trigram scheme) to produce an output sentence 260.

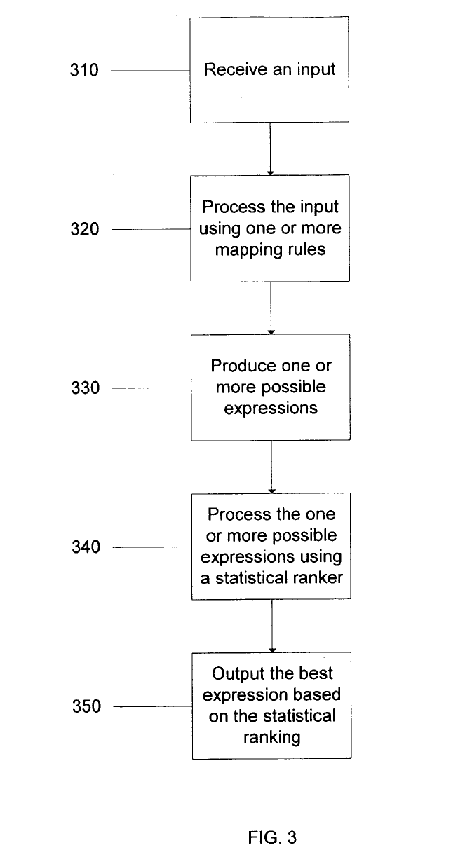

System 200 of FIG. 2 may be used to produce a sentence using an input. Referring to FIG. 3, a process using a system such as system 200 may include receiving an input (310), where the input may represent one or more ideas to be expressed in a sentence.

The input may be processed using one or more mapping rules (320) to produce one or more possible expressions (330). The one or more possible expressions may in turn be processed using a statistical ranker (340), which may output the best expression based on the statistical ranking (350).

System Inputs

Current systems and techniques may use a labeled feature-value structure for input. Labels, when included, may be arbitrary symbols used to identify a set of feature-value pairs. Features are represented as symbols preceded by a colon. Features may express relationships between entities, or properties of a set of relationships or of an atomic value. The value of a feature can be an atomic entity, or a label, or recursively another labeled set of feature value pairs.

The most basic input is a leaf structure of the form: (label/word-or-concept). Inputs that may be used to represent phrases such as “the dog,” “the dogs,” “a dog,” or “dog” include Examples 1 and 2 below:

| | |
|---|---|
| (m1/“dog”) | Example (1) |
| (m1/\|dog < canid\|) | Example (2) |

The slash (/) is shorthand for the “:instance” feature (a fundamental relation). In logic notation, the input above may be written as Instance (m1, DOG).

The “:instance” feature also represents the semantic or syntactic head of a set of relationships. The value of the instance feature can be a word or a concept. A word may be enclosed in string quotes, and the system may require that the word be in root form.

A concept may be expressed as a valid Sensus symbol, which is a mnemonic name for a WordNet synset enclosed in vertical bars. The Sensus Ontosaurus Browser may be accessed, for example, via http://Mozart.isi.edu:8003/sensus2, and may be used to look up concept names for words and synset classes. A concept generally represents a unique meaning and can map to one or more words.

Fully specified and minimally specified inputs

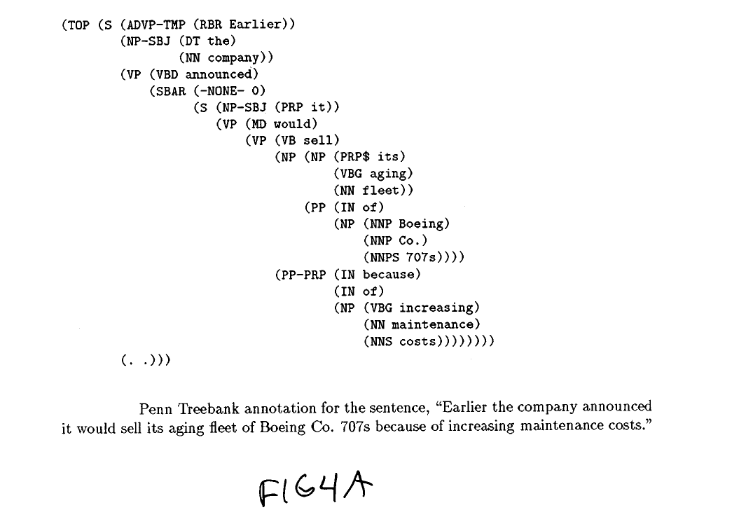

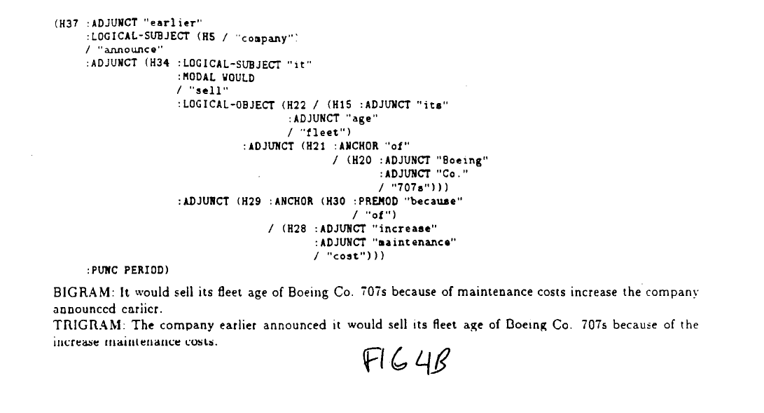

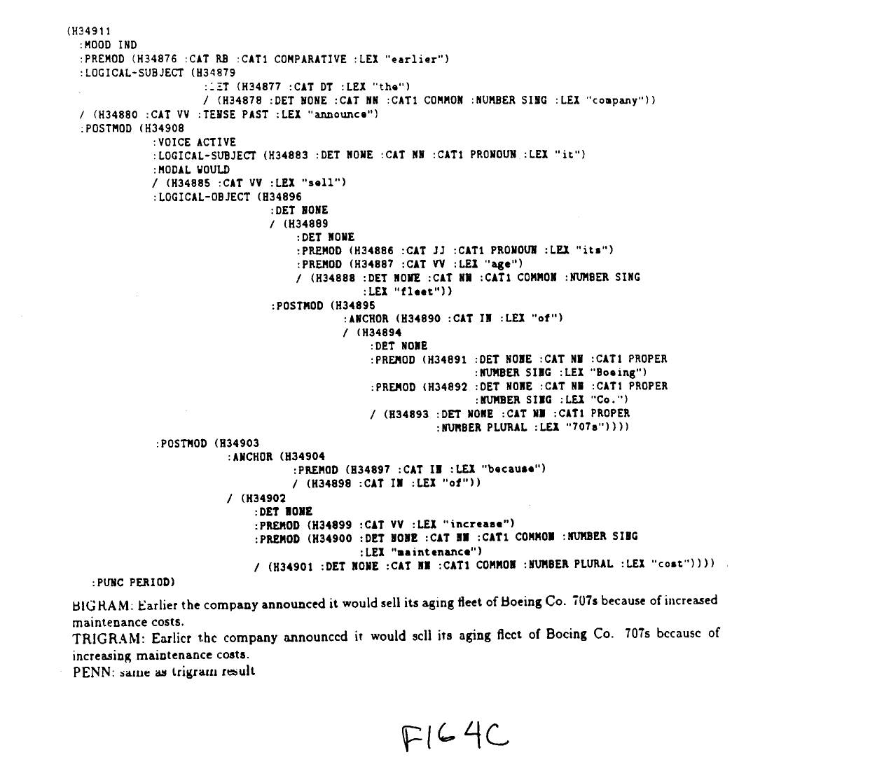

The current system may use inputs that are not fully specified. FIG. 4A shows a Penn Treebank annotation for the sentence “Earlier the company announced it would sell its aging fleet of Boeing Co. 707s because of increasing maintenance costs.” FIG. 4B shows an example of a minimally specified input for the sentence of FIG. 4A and the output that may be obtained using a system as described herein. FIG. 4C shows an example of an almost fully specified input for the sentence of FIG. 4A and the output that may be obtained.

Relation Features

Relation features describe the relationship between the instance value and another content-bearing value. A content-bearing value may be a simple word or concept (e.g. “dog” in Examples (1) and (2) above), or may be a compound value including, e.g., nested feature-value structures.

Examples (3) and (4) below both express the idea “The dog eats a meaty bone.” Example (3) uses syntactic relations, while Example (4) also uses semantic relations. Note that the value labeled ‘b1’ in each example is a compound value.

| | |
|---|---|
| (e1/eat | Example (3) |
| :subject (d1/dog) | |
| :object (b1/bone | |
| :premod (m1/meaty))) | |
| (e1/eat | Example (4) |
| :agent (d1/dog) | |
| :patient (b1/bone | |
| :premod (m1/meaty))) | |

As shown in Examples (3) and (4), multiple relations can appear at a nesting level in the input. Some relations can only occur once at any given nesting level. Others, including modifier and adverbial relations (adjuncts), can occur multiple times.

Relations may be order-independent, so that the order in which the relations occur in the input does not affect the order in which their values occur in the output. However, there may be exceptions. For example, a conditional exception may occur when the same relation occurs more than once in a nesting level.

The system may deal with this in a number of ways. For example, a “permute nodes” flag may be used, where setting the flag to “nil” causes the values with the same relation to occur adjacent to each other in the output in the same order that they appeared in the input. Setting the flag to “true” causes the values to occur adjacent to each other in an order determined by a statistical model.

The system may recognize relations such as shallow syntactic relations, deep syntactic relations, and semantic relations. These relations may be recognized by mapping rules used by the symbolic generator to produce the forest of possible expressions. The mapping rules may be extended to recognize other relations (e.g., non-linguistic and/or domain-specific relations). Table 1 below lists relations that may be used by the system, organized by relation type.

TABLE 1

| Relation type | Relation |
|---|---|
| Shallow Syntactic | :SUBJECT |
| | :OBJECT |
| | :DATIVE |
| | :COMPLEMENT |
| | :PREDICATE |
| | :ANCHOR |
| | :PREMOD |
| | :POSTMOD |
| | :WITHINMOD |
| | :PREDET |
| | :TOPIC |
| | :CONJ |
| | :INTROCONJ |
| | :BCPP |
| | :COORDPUNC |
| | :LEFTPUNC |
| | :RIGHTPUNC |
| | :DETERMINER |
| Deep Syntactic | :LOGICAL-SUBJECT |
| | :LOGICAL-OBJECT |
| | :LOGICAL-DATIVE |
| | :LOGICAL- SUBJECT-OF |
| | :LOGICAL OBJECT-OF |
| | :LOGICAL-DATIVE-OF |
| | :ADJUNCT |
| | :CLOSELY-RELATED |
| | :QUESTION |
| | :PUNC |
| | :SANDWICHPUNC |
| | :QUOTED |
| Semantic | :AGENT |
| | :PATIENT |
| | :RECIPIENT |
| | :AGENT-OF |
| | :PATIENT-OF |
| | :RECIPIENT-OF |
| | :DOMAIN |
| | :RANGE |
| | :DOMAIN-OF |
| | :SOURCE |
| | :DESTINATION |
| | :SPATIAL-LOCATING |
| | :TEMPORAL-LOCATING |
| | :ACCOMPANIER |
| | :SANS |
| | :ROLE-OF = AGENT |
| | :ROLE-OF-PATIENT |
| | :MANNER |
| | :MEANS |
| | :CONDITION |
| | :THEME |
| | :GENERICALLY-POSSESSED-BY |
| | :NAME |
| | :QUANT |
| | :RESTATEMENT |
| | :GENERICALLY-POSSESSES |
| Miscellaneous | :INSTANCE |
| | :OP |
| | :PRO |
| | :TEMPLATE |
| | :FILLER |

Different, more, or fewer relations may be used, according to different implementations. Although the relations in Table 1 are grouped according to degree of abstraction, there need not be a formal definition of a level of abstraction to separate the different levels. Instead, relations at different levels of abstraction may be mixed in the same input and at the same level of nesting.

Mappings from a deeper relation to a shallower relation may capture an equivalence that exists at the shallower level. Abstraction may be treated as a continuum rather than as a discrete set of abstraction levels. The continuum approach may increase the flexibility of the input from a client perspective, and may also increase the conciseness and modularity of the symbolic generator's mapping rules.

The continuum approach may also simplify the definition of paraphrases. The ability to paraphrase may be important in a general purpose sentence generator. Herein, the term paraphrase refers to one or more alternations sharing some equivalence that is encapsulated in a single representation using one or more relations at a deeper level abstraction. Alternations sharing the equivalency are produced using the deeper input. Generation of paraphrases may be controlled or limited using a property feature if desired.

Property features (see below) may be used to at least partially overcome the problems of subjectivity that may plague deeper levels of abstraction. Examples of property features that may be used to define deeper levels of abstraction include voice, subject-position, and the syntactic category of a dominant constituent (i.e., whether the phrasal head is a noun versus a verb).

Using this definition style, equivalencies at higher levels of abstraction generally produce a greater number of variations or paraphrases than those at lower levels of abstraction. Therefore, the system has the ability to generate a large number of paraphrases given an input at a deep level of abstraction, as well as the ability to limit the variation in a principled way by specifying relevant property features or using a shallower level of abstraction.

The system may recognize and process semantic relations, such as those defined and used in the GAZELLE machine translation project. Additionally, the system may map semantic relations to one or more syntactic relations.

As a result, the system may be able to paraphrase concepts such as possibility, ability, obligatoriness, etc. as modal verbs (e.g., may, might, can, could, would, should, must) using the :domain relation. By having access to other syntactic structures to express these ideas, the system can generate sentences even when a domain relation is nested inside another domain, and when any combination of polarity is applied to inner and outer domain instances (even though modal verbs themselves cannot be nested).

For example, the following sentence is not grammatical: “You may must eat chicken” (i.e., the nested modal verb structure is ungrammatical). However, the system may access other syntactic structures to paraphrase the concepts. For example, the system may produce the grammatically correct paraphrase: “You may be required to eat chicken.”

Another consequence of the ability to map semantic relations to syntactic relations allows for the system to capture the equivalence between alternations like “Napoleon invaded France” and “Napoleon's invasion of France.” The :agent and :patient semantic relations are used to represent the similarity between expressions whose semantic head is realized as a noun versus as a verb. That is, :agent (i.e. Napoleon) can map to either :logical-subject (to produce “Napoleon invaded France”), or to :generalized-possession-inverse, which can produce a possessive phrase using an 's construction (i.e., “Napoleon's invasion of France.”) The :patient relation (i.e. France) maps to either :logical-object or to :adjunct with a prepositional anchor like “of.”

Deep syntactic relations may capture equivalencies that exist at the shallow syntactic level. For example, the :logical-subject, :logical-object, and :logical-dative relations capture the similarity that exists between sentences that differ in active versus passive voice. For example, the two sentences “The dog ate the bone” and “The bone was eaten by the dog” would both be represented at the deep syntactic level as shown in Example (5) below:

| | |
|---|---|
| (e1/eat | Example (5) |
| :logical-subject (d1/dog) | |
| :logical-object (b1/bone)) | |

To further specify the voice, the :voice feature may be used. With “active” voice, :logical-subject would map to :subject and :logical-object would map to :object. In contrast, with “passive” voice, :logical-object would map to :subject and :logical-subject would map to :adjunct with the addition of a prepositional anchor “by.”

The adjunct relation at the deep syntactic level maps to either :premod, :postmod, or :withinmod at the syntactic level, abstracting away from ordering information to capture the similarity that all three syntactic relations are adjuncts. The :closely-related relation can be used to represent the uncertainty of whether a particular constituent is, for example, a required argument of a verb, or an optional adjunct. The question relation consolidates in one relation the combination of three syntactic features that can sometimes be independent.

For example, Example (6) and Example (7) below show two equivalent inputs to represent “What did the dog eat?”

| | |
|---|---|
| (e1/eat | Example (6) |
| :question (b1/what) | |
| :subject (d1/dog)) | |
| (e1/eat | Example (7) |
| :topic (b1/what) | |
| :subject (d1/dog) | |
| :subject-position post-aux | |
| :punc question_mark) | |

The :punc relation generalizes the :leftpunc, :rightpunc, and :sandwichpunc relations. The :sandwichpunc relation is itself a generalization of the combination of both :leftpunc and :rightpunc.

The shallow syntactic relations shown in Table 1 include subject, object, predicate, etc., as well as other relations. For example, the :predet relation broadly represents any head noun modifier that precedes a determiner. The :topic relation may include question words/phrases. The :anchor relation represents both prepositions and function words like “that,” “who,” “which,” etc., that may be viewed as explicitly expressing the relation that holds between two content-bearing elements of a sentence.

Other shallow syntactic relations may relate to coordinated phrases. Coordinated phrases may be represented in a number of ways. Examples (8) and (9) below show two ways of representing coordinated phrases:

| | |
|---|---|
| (c1/and | Example (8) |
| :op (a1/apple) | |
| :op (b1/banana)) | |
| (c1/(a1/apple) | Example (9) |
| /(b1/banana) | |
| :conj (d1/and)) | |

The representation of coordinated phrases may combine elements of dependency notation and phrase-structure notation. At the lowest level of abstraction, coordination may be signaled by the presence of more than one instance relation. Besides :conj, the relations that may be involved in coordinated phrases include :coordpunc, :bcpp, and :introconj. The system may be configured so that, if not specified, :coordpunc usually defaults to :comma, but defaults to :semicolon when coordinated phrases already contain commas. However, the system may be configured so that :coordpunc may be specified to be words like “or” (as in the example “apples or oranges or bananas). Alternately, :coordpunc may be specified to be other types of punctuation.

The relation :bcpp is a Boolean property that may be used to control whether a value specified by :coordpunc occurs immediately before the conjunction. For example, if :bcpp is specified as true, then “a, b, and c” may be generated, while if :bcpp is specified as false, “a, b and c” may be generated. The default for :bcpp may be false unless more than two entities are being coordinated.

The relation :introconj may be used to represent the initial phrases that occur in paired conjunctions. For example, :introconj may represent phrases such as “not only . . . but,” and “either . . . or.”

Relations may be aliased to accommodate the varying nomenclature of different applications. For example, :agent may be referred to as :sayer or :sensor, while :dative may be referred to as :indirect-object.

The system may also allow instances to be compound nodes rather than being restricted to atomic values as in some prior art systems. This may provide a number of benefits, including providing a flexible means of controlling adjunct generation and allowing the representation of scope. Examples (10) and (11) below illustrate controlling adjunct generation using compound nodes.

| | |
|---|---|
| (c1/flight | Example (10) |
| :postmod (l1/“Los Angeles” | |
| :anchor “to”) | |
| :postmod (m1/“Monday” | |
| :anchor “on”)) | |
| (c1/(f1/flight) | Example (11) |
| :postmod (l1/“Los Angeles” | |
| :anchor “to”)) | |
| :postmod (m1/“Monday” | |
| :anchor “on”)) | |

The inputs shown in Examples (10) and (11) have equivalent meanings. However, Example (11) constrains the set of possible outputs. That is, the input of Example (10) may produce both “a flight to Los Angeles on Monday” and “a flight on Monday to Los Angeles,” while the input of Example (11) constrains the output to only the second variant.

Such output constraints may be desired by some applications of the general purpose system described herein. For example, in some applications the outputs may be constrained for rhetorical reasons (such as to generate a response that parallels a user utterance).

The nesting of the Instance relation specifies a partial order on the set of relations so that those in the outer nest are ordered more distantly from the head than those in the inner nest. In some implementations, the same thing may be accomplished by setting a “permute-nodes” flag to false.

The semantic notion of scope can be added to a nested feature-value set via the :unit feature. Example (12) below shows how the :unit feature may be used to generate “the popular University of Southern California,” where the :unit feature and the nested structure indicate that the adjunct “popular” modifies the entire phrase “University of Southern California” rather than the term “University” alone.

| | |
|---|---|
| (c1/(u1/“University: | Example (12) |
| :postmod (c1/“California: | |
| :adjunct (s1/“Southern”) | |
| :anchor “of”) | |
| :unit +) | |
| :adjunct (p1/popular)) | |

The system may also be configured so that a meta-level *OR* may be used to express an exclusive-or relationship between a group of inputs or values. Semantically, it represents ambiguity or a choice between alternate expressions. It may also be viewed as a type of under-specification. The statistical ranker may then choose among the alternate expressions, as described below.

The input shown in Example (13) below represents two semantic interpretations of the clause “I see a man with a telescope,” with a choice between the words “see” and “watch” and with an ambiguity about whether John said it or Jane sang it.

| | |
|---|---|
| (*OR* (a1/say | Example (13) |
| :agent (j1/“John”) | |

```
    :saying (*OR* (s1/(*OR* see watch)
    :agent I
    :patient (m1/man
    :accompanier (t1/telescope)))
    (s2/see
    :agent I
    :patient (m2/man)
    :instrument (t1/telescope)))
    (a2/sing
    :agent (j2/“Jane”)
    :saying (*OR* s1 s2)))
```

The system may also enable template-like capability through the :template and :filler features. Example (14) shows an input using the :template and :filler features to produce the output “flights from Los Angeles.”

| | |
|---|---|
| (a1 :template (f1/flight | Example (14) |
| :postmod (c1/l1 | |
| :anchor from)) | |
| :filler (l1/Los Angeles)) | |

Property Features

The system may also be configured to process inputs including property features such as atomic-valued property features. Property features describe linguistic properties of an instance or a clause. In an implementation, property features are not generally included as inputs, but may be used to override defaults. Table 2 shows some property features that may be used.

| | | |
|---|---|---|
| VERB | Mood | Infinitive, infinitive-to, |
| | | imperative, present-participle, |
| | | past-participle, indicative |
| | Tense | Present, past |
| | Person | s, (3s) , p (1s, 1p, 2s, 2p, 3p), |
| | | all, nill |
| | Modal | Should, would, could, may, might, |
| | | must, can, will |
| | Taxis | Perfect, none |
| | Aspect | Continuous, simple |
| | Voice | Active, passive |
| | Subject- | Default, post-aux, post-vp |
| | position | |
| | Passive- | Logical-object, logical-dative, |
| | subject- | logical-postmod |
| | role | |
| | Dative- | Shifted, unshifted |
| | position | |
| NOUN | CAT1 | Common, proper, pronoun, cardinal |
| | Number | Singular, plural |
| ADJECTIVE | CAT1 | Comparative, superlative, negative |
| or ADVERB | | (“not”), nil, cardinal, possessive, |
| | | wh |
| GENERAL | LEX | Root form of a word as a string |
| | SEM | A SENSUS Ontosaurus concept |
| | CAT | Open class: vv, nn, jj, rb |
| | | Closed class: cc, dt, pdt, in, to, |
| | | rp, sym, wdt, wp, wrb, uh |
| | | Punctuation: same as Treebank |
| | RHS | Inflected form of a word as a string |
| | Polarity, | +, − |
| | gap | |

Example (15) below shows an input using a property feature that specifies that a noun concept is to be plural:

| | |
|---|---|
| (m2/\|dog < canid\| | Example (15) |
| :number plural) | |

Using the :number property narrows the meaning to “the dogs” or “dogs.” If the :number property were not specified, the statistical ranker would choose among singular and plural alternatives.

Property features may allow more specific inputs and thus better output. However, the current system is able to deal with underspecified inputs effectively, by virtue of the mapping rules and the statistical ranker.

Property features may also be used to generate auxiliary function words. For example, verb properties such as :modal, :taxis, aspect, and :voice may be used to generate auxiliary function words. In combination with the verbal :mood property, these four features may be used to generate the entire range of auxiliary verbs used in English.

Example (16) below illustrates a possible use of verbal properties by explicitly specifying values for possible properties.

| | |
|---|---|
| (e1 / “eat” | Example (16) |

:mood indicative
:modal “might”
:taxis none
:aspect continuous
:voice active
:person 3s
:subject (j1 / “Jane”)
:subject-position default
:object (i1 / “ice cream”))

The output based in the input shown in Example (16) is “Jane might be eating ice cream.”

The :taxis feature generates perfect tense when specified (“might have been eating”). The default may be that :taxis none is generated. The :aspect feature may generate continuous tense when specified as in Example (16). If :aspect is not specified, the default may be :aspect simple, which would generate “Jane might eat ice cream.”

The :voice feature may be passive or active. Had passive voice been specified above, “Ice cream might have been eaten by Jane” would have been generated. The default of the :modal feature may be set to none.

The :person feature has six primary values corresponding to each combination of person (i.e., first, second, and third person) and verbal number (singular or plural), as shown in Table 3 below.

TABLE 3

| | Singular | Plural |
|---|---|---|
| First | (I) eat | (we) eat |
| Second | (you) eat | (you) eat |
| Third | (he, she, it) eats | (they) eat |

Since verbs (except “be”) generally have a distinct value for only third-person singular, the :person feature value may be abbreviated as just “s” (for “3s”) or “p” (for all others). If :person is not specified, the system may generate a set of unique inflections, and choose among them using the statistical ranker.

The :subject-position feature may have two non-default values: “post-aux” and “post-vp.” The post-aux value may be used to produce questions and some inverted sentences, such as “Might Jane be eating ice cream?” and “Marching down the street was the band” (e.g., by also using the :topic relation with the main verb). The :post-vp value may be used, for example, in combination with the verb “say” and its synonyms, together with the :topic relation, which shifts verbal constituents to the front of the sentence. An example output would be “‘Hello!,’ said John.”

Sentence Generation

Sentence generation may include two parts. First, the input is processed by a symbolic generator to produce a set of possible expressions (referred to as “a forest”). Second, the possible expressions are ranked using a statistical ranker.

Symbolic Generator

The symbolic generator maps inputs to a set of possible expressions (a forest). The tasks that the symbolic generator performs may include mapping higher-level relations and concepts to lower-level ones (e.g., to the lowest level of abstraction), filling in details not specified in the input, determining constituent order, and performing morphological inflections.

The symbolic generator may use lexical, morphological, and/or grammatical knowledge bases in performing these tasks. Some linguistic decisions for realizing the input may be delayed until the statistical ranking stage. Rather than making all decisions, the symbolic generator may itemize alternatives and pack them into an intermediate data structure.

The knowledge bases may include, for example, a dictionary such as a Wordnet-based dictionary, a lexicon such as a closed-class lexicon and an application-specific lexicon, morphological inflection tables, and input mapping rules.

Sensus Concept Ontology

The system may use Sensus concept ontology, which is a WordNet-based hierarchy of word meanings segregated at the top-most level into events (verbal concepts), objects (nominal concepts), qualities (adjectives), and adverbs. Each concept represents a set of synonyms, referred to as a synset. The ontology lists approximately 110,000 tuples of the form: (<word><part-of-speech><rank><concept>), such as (“Eat” VERB 1 |eat, take in|). The <rank> field orders the concepts by sense frequency for the given word, with a lower number signifying a more frequent sense.

Unlike other generators, the current system can use a simple lexicon without information about features like transitivity, sub-categorization, gradability (for adjectives), countability (for nouns), etc. Other generators may need this additional information to produce correct grammatical constructions. In contrast, the current system uses a simple lexicon in the symbolic generator and uses the statistical ranker to rank different grammatical realizations.

At the lexical level, issues in word choice arise. WordNet maps a concept to one or more synonyms. However, depending on the circumstances, some words may be less appropriate than others, or may be misleading in certain contexts.

For example, the concept |sell<cozen| represents the idea of deceit and betrayal. The lexicon maps it to both “betray” and “sell” (as in a traitor selling out his friends). However, use of the word “sell” to convey the meaning of deceit and betrayal is less common, and may be misleading in contexts such as “I cannot |sell<cozen| their trust.” It is thus less appropriate than using the word “betray.” Word choice problems such as these may occur frequently.

The system may use the word-sense rankings to deal with the problem. According to the lexicon, the concept |sell<cozen| expresses the second most frequent sense of the word “betray,” but only the sixth most frequent sense of the word “sell.”

The system may use a heuristic of associating with each word a preference score. For example, a weight may be assigned according to a formula such as Equation (1):

$$weight = \frac{1}{{ⅇ}^{( rank - 1 )}} \qquad Equation ( 1 )$$

The statistical ranker may use the weight to choose the most likely alternative. Other methods may be used to weight particular alternatives. For example, Bayes' Rule or a similar method may be used, or probabilities computed using a corpus such as SEMCOR may be used weighting factors may also be specified in inputs, included in some other aspect of the knowledge base, and/or be included in one or more rules.

Another issue in word choice relates to the broader issue of preserving ambiguities, which may be important for applications such as machine translation. It may be difficult to determine which of a number of concepts is intended by a particular word. In order to preserve the ambiguity, the system may allow alternative concepts to be listed together in a disjunction. For example, the input (m6/(*OR*|sell<cosen| |cheat on| |betray| |betray, fail| |rat on|)) reflects the ambiguity in the term “sell.” The system may attempt to preserve the ambiguity of the *OR*.

However, if several or all of the concepts in a disjunction can be expressed using the same word or words, the lookup may return only that word or those words in preference to other alternatives. In the example above, the lookup may return only the word “betray.” By doing so, the system may reduce the complexity of the set of candidate sentences.

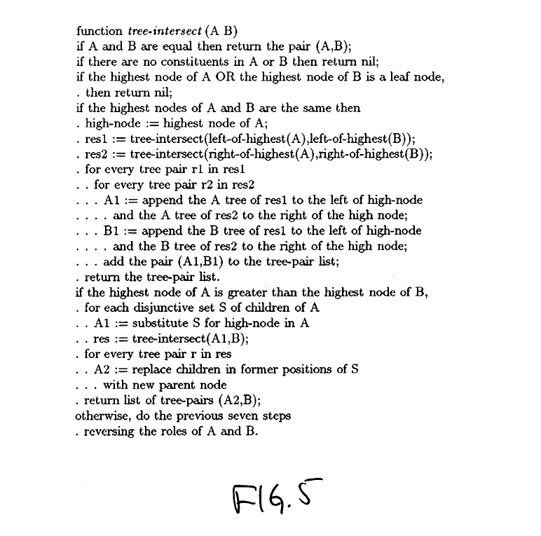

FIG. 5 shows an algorithm that may be used to preserve ambiguities. The ambiguity preservation process may be triggered when an input contains a disjunction, where a parenthesized list with *OR* is the first element and two or more additional elements representing inputs or input fragments to be chosen from.

The ambiguity preservation process may be controlled in a number of ways. There may be a general system flag that can be set to true or false to turn on or off the ambiguity preservation procedure. If the flag is set to false, the alternative forests generated by the disjoined input fragments may simply be packed into the forest as alternatives, with no deliberate preservation of ambiguity. If the flag is set to true, only the result forest that remains from intersecting the respective forests produced by the input fragments may be passed on to the statistical ranker. An alternate scheme involves a different disjunction symbol *AOR* to indicate to the system that the ambiguity preservation procedure should be used to process the corresponding input fragments.

Closed Class Lexicon

The system may include a closed class lexicon, which may include entries of the following form: (:cat <cat> :orth <orthography> :sense <sense>). Examples include:

(:cat ADJ :orth “her”:sense 3s_fem_possessive)

(:cat CC :orth “and”:sense cc_{—}0)

(:cat DT :orth “a”:sense indef_det)

(:cat IN :orth “with”:sense with)

(:cat MD :orth “can”:sense modal_verb)

(:cat NOUN :orth “he”:sense 3s_pronoun)

(:cat PDT :orth “all”:sense pdt_{—}0)

(:cat RB :orth “when”:sense wrb_{—}2)

(:cat RP :orth “up”:sense rp_{—}27)

(:cat WDT :orth “which”:sense wdt_clocla)

(:cat UH :orth “ah”:sense uh_{—}0)

(:cat |-COM-| :orth “,”:sense comma)

Application-Specific Lexicon

The system may allow for a user-defined lexicon that may be used to customize the general-purpose system described herein. The application-specific lexicon may be consulted before other lexicons, to allow applications to override the provided knowledge bases rather than change them.

The user-defined lexicon may include entries of the form: (<concept> <template-expansion>). An example of an entry is the following: (|morning<antemeridian| (*OR* (:cat NN :lex “a.m.”) (:cat NN :lex “morning”))).

Morphological Knowledge

The system may include morphological knowledge. The lexicon generally includes words in their root form. To generate morphological inflections (e.g., plural nouns and past tense verbs), a morphological knowledge base may be used.

The system may also include morphological knowledge such as one or more tables for performing derivational morphology such as adjective to noun and noun to verb derivation (e.g., “translation” becomes “translate.”) Morphological knowledge may enable the system to perform paraphrasing more effectively, and may provide more flexibility in expressing an input. It may else help mitigate problems of syntactic divergence in machine translation applications.

The system may implement a morphological knowledge base by providing pattern rules and exception tables. The examples below show a portion of a table for pluralizing nouns:

(“-child” “children”)
(“-person” “people” “persons”)
(“-a” “as” “ae”); formalas/formulae
(-x” “xes” “xen”); boxes/oxen
(“-man” “mans” “men”); humans/footmen
(“-Co” “os” “oes”)

The last example instructs the system that if a noun ends in a consonant followed by “-o,” the system should produce two plural forms, one ending in “-os” and one ending in “-oes,” and store both possibilities for the statistical ranker to choose between later. Again, corpus-based statistical knowledge may greatly simplify the task of symbolic generation.

Mapping Rules

The symbolic generator may use a set of mapping rules in generating alternative expressions. Mapping rules map inputs into an intermediate data structure for subsequent ranking. The left hand side of a mapping rule specifies the conditions for matching, such as the presence of a particular feature at the top-level of the input. The right-hand-side lists one or more outcomes.

In applying mapping rules, the symbolic generator may compare the top level of an input with each of the mapping rules. The mapping rules may decompose the input and recursively process the nested levels. Base input fragments may be converted into elementary forests and then recombined according to the mapping rules to produce the forests to be processed using the statistical ranker.

In an implementation, there are 255 mapping rules of four kinds: recasting rules, ordering rules, filling rules, and morphing rules.

Recasting Rules

Recasting rules map one relation to another. They are used, for example, to map semantic relations into syntactic ones, such as :agent into :subject or :object. Recasting rules may enable constraint localization. As a result, the rule set may be more modular and concise. Recasting rules facilitate a continuum of abstraction levels from which an application can choose to express an input. They may also be used to customize the general-purpose sentence generator described herein. Recasting rules may enable the system to map non-linguistic or domain-specific relations into relations already recognized by the system.

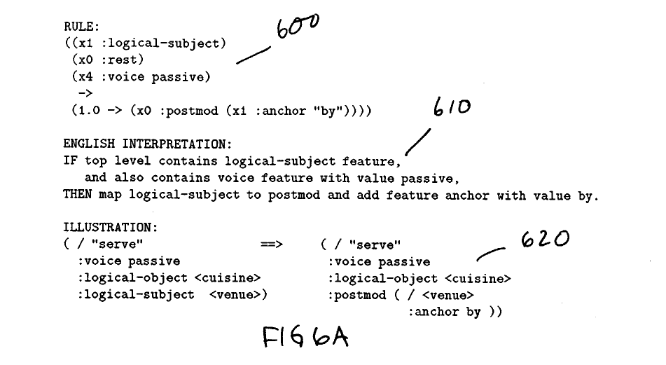

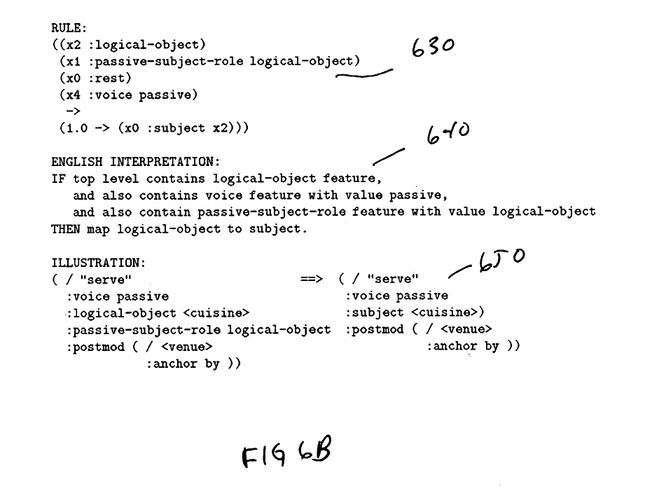

FIG. 6A shows an example of a recasting rule 600, an English interpretation 610 of rule 600, and an illustration 620 of rule 600. FIG. 6B shows an example of a recasting rule 630, an English interpretation 640 of rule 630, and an illustration 650 of rule 630.

Recasting rules may also allow the system to handle non-compositional aspects of language. One area in which this mechanism may be used is in the domain rule. The sentence “It is necessary that the dog eat” may be represented as shown in Example (17):

| | |
|---|---|
| (m8 / \|obligatory<necessary\| | Example (17) |

:domain (m9 / |eat, take in|
:agent (m10 / |dog, canid|)))

At other times, the sentence may be represented as

shown in Example (18):

| | |
|---|---|
| (m11 / \|have the quality of being\| | Example (18) |

:domain (m12 / |eat, take in|
:agent (d / |dog, canid|))
:range (m13 / |obligatory<necessary|))

Examples (17) and (18) may be defined as semantically equivalent. Both may be accepted, and the first may be automatically transformed into the second.

Alternate forms of this sentence include “The dog is required to eat,” or “The dog must eat.” However, the grammar formalism may not directly express this, because it would require inserting the result for |obligatory<necessary| within the result for m9 or m12, while the formalism may only concatenate results. The recasting mechanism may be used to solve this problem by recasting Example (18) as in Example (19) below:

| | |
|---|---|
| (m14 / \|eat, take in\| | Example (19) |
| :modal (m15 / \|obligatory<necessary\|) | |
| :agent (m16 / \|dog, candid\|)) | |

so that the sentences may be formed by concatenation of the constituents. The syntax for recasting the first input to the second is:

```
((x2 :domain)
  (not :range)
  (x0 (:instance /))
  (x1 :rest)
->
(1.0 -> (/ |hqb| :domain x2 :range (/ x0 :splice
```

x1))))

```
and for recasting the second into the third:
((x2 :domain)
  (x3 :range)
  (x0 (:instance /))
  (x1 :rest)
->
(1.0 -> (x2 :semmodal (/ x3) :splice x1))
Filling rules
```

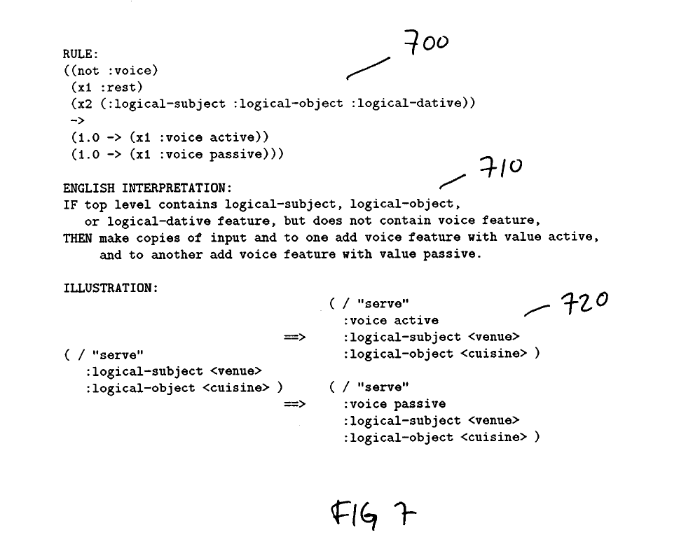

A filling rule may add missing information to underspecified inputs. Filling rules generally test to determine whether a particular feature is absent. If so, the filling rule generates one or more copies of the input, one for each possible value of the missing feature, and add the feature-value pair to the copy. Each copy may then be independently circulated through the mapping rules. FIG. 7 shows an example of a filling rule 700, an interpretation 710 of rule 700, and an illustration 720 of rule 700.

Ordering Rules

Ordering rules assign a linear order to the values whose features matched with the rule. Ordering rules generally match with syntactic features at the lowest level of abstraction.

An ordering rule may split an input into several pieces. The values of the features that matched with the rule may be extracted from the input and independently recirculated through the mapping rules. The remaining portion of the original input may then continue to circulate through the rules where it left off. When each of the pieces finishes circulating through the rules, a new forest node may be created that composes the results in the designated linear order.

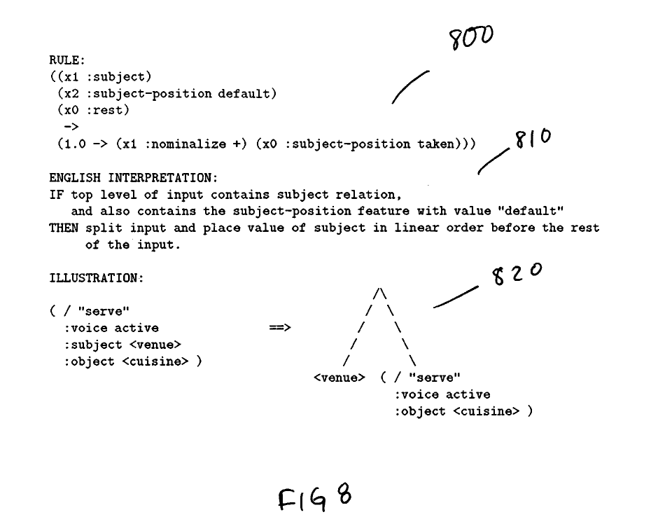

FIG. 8 shows an example of an ordering rule 800, an English interpretation 810 of rule 800, and an illustration 820 of rule 800.

Morphological Inflection (Morph) Rules

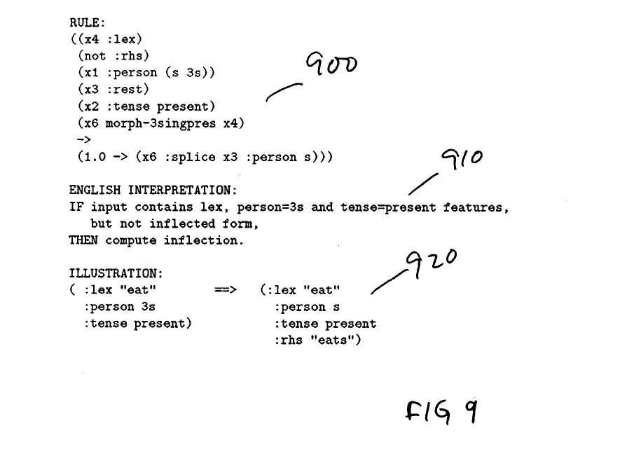

A morph rule produces a morphological inflection of a base lexeme, based on the property features associated with it. FIG. 9 shows an example of a morph rule 900, an English interpretation 910 of rule 900, and an illustration 920 of rule 900.

Forest Representation

The results of symbolic generation may be stored in an intermediate data structure such as a forest structure. A forest compactly represents a large, finite set of candidate realizations as a non-recursive context-free grammar. It may also be thought of as an AND-OR graph, where AND nodes represent a sequence of elements, and OR nodes represent a choice between mutually exclusive alternatives. A forest may or may not encode information about linguistic structure of a sentence.

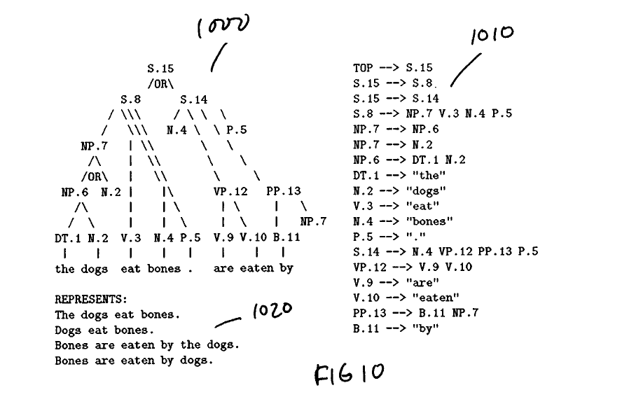

FIG. 10 shows an example of a forest 1000, its internal representation 1010, and a list of different sentences 1020 it represents. Nodes of forest 1000 are labeled with a symbol including an arbitrary alpha-numeric sequence, then a period, then a number. The alpha-numeric sequence may be used to improve readability of the forest. The number identifies a node. The TOP node is special and is labeled simply “TOP.”

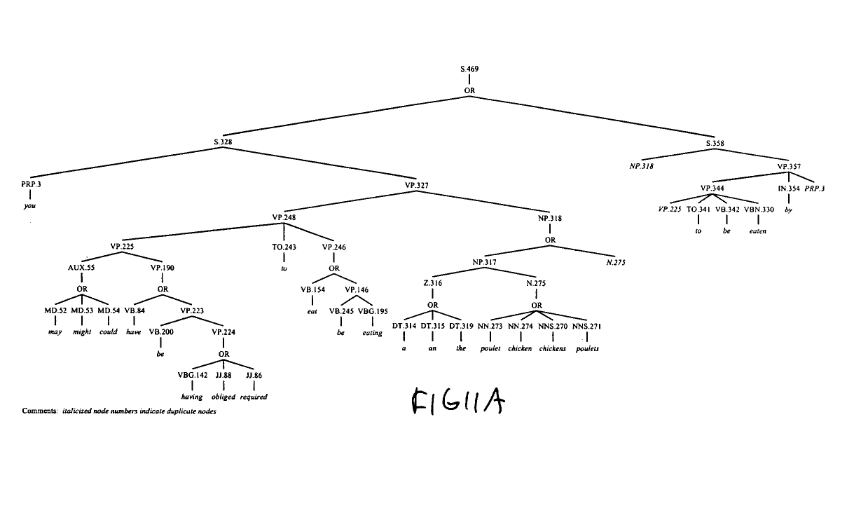

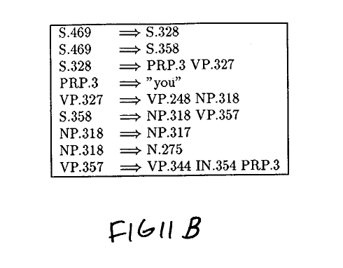

FIG. 11A shows another example of a forest 1100, while FIG. 11B shows an internal PF representation (see below) of the top three levels of nodes in the forest shown in FIG. 11A.

A forest may include two types of rules: leaf and non-leaf. A leaf rule has only one item on its right-hand side: an output word enclosed in double quotes. A non-leaf node may have any number of items on its right-hand side, which are labels for a sequence of child nodes. The presence of multiple rules with the same left-hand side label represents a disjunction, or an OR node.

Alternatively, a third type of rule may be used to represent OR nodes to simplify implementation. This third type of rule may have the same structure as a non-leaf sequence node, except that it contains an OR-arrow symbol (“OR→”) in place of a simple arrow. This alternate representation of OR nodes may be referred to as a generation forest (GF) representation, while the first form is referred to as a parse forest (PF) representation. In a GF representation, a label appears on the left-hand side of a rule only once. In a GF representation, the four rules in FIG. 10 that represent the two OR-nodes would be represented textually using only two rules:

S.15 OR→S.8 S.14

NP.7 OR→NP.6 N.2

Realization Algorithm

The system may realize one or more outputs as follows. The symbolic generator may compare the top level of an input with each of the mapping rules in turn. Matching rules are executed. The mapping rules transform or decompose the input and recursively process the new input(s). If there is more than one new input, each may be independently recirculated through the rules. The system converts base input fragments into elementary forests and then recombines them according to the specification of the respective mapping rules as each recursive loop is exited.

When a rule finishes executing, the result is cached together with the input fragment that matched it. Since the system may extensively overgenerate, caching may be used to improve efficiency. Each time a matched rule transforms or decomposes an input, the new sub-input(s) may be matched against the cache before being recursively matched against the rule set.

If execution of a particular rule is not successful, the original input may continue matching against the rest of the rule set. Rematching takes similar advantage of the cache. If no match or rematch exists, generation of a particular sub-input may fail.

Rules may be ordered so that those dealing with higher levels of abstraction come before those dealing with lower levels. Ordering rules generally provide the lowest level of abstraction. Among ordering rules, those that place elements farther from the head come before those that place elements closer to the head. As rule matching continues, ordering rules extract elements from the input until only the head is left. Rules that perform morphological inflections may operate last. Filling rules may come before any rule whose left-hand-side matching conditions might depend on the missing feature.

Dependencies between relations may thus govern the overall ordering of rules in the rule set. The constraints on rule order define a partial-order, so that within these constraints it generally does not matter in what order the rules appear, since the output will not be affected. The statistical ranker processes the resulting forest after the mapping rules have executed.

Statistical Ranker

The statistical ranker determines the most likely output among possible outputs. The statistical ranker may apply a bottom-up dynamic programming algorithm to extract the N most likely phrases from a forest. It may use an ngram language model, for example, an ngram language model built using Version 2 of the CMU Statistical Modeling Toolkit. The ranker finds an optimal solution with respect to the language model.

The statistical ranker may decompose a score for each phrase represented by a particular node in the forest into a context-independent (internal) score, and a context-dependent (external) score. The internal score may be stored with the phrase, while the external score may be computed in combination with other nodes such as sibling nodes.

An internal score for a phrase associated with a node p may be defined recursively as shown in Equation (2) below:

I(p)=πⱼ₌₁^{J}I(cⱼ)*E(cⱼ|context(c₁ . . . cⱼ₋₁)) Equation (2)

where I is the internal score, E is the external score, and cⱼ is a child node of p. The formulation of I and E, as well as the definition of context may be chosen according to the language model being used. For example, in a bigram model, I=1 for leaf nodes, and E may be expressed as shown in Equation (3) below:

E=P(FirstWord(cⱼ)|LastWord(cⱼ−1)) Equation (3)

In Equation (3), P refers to a probability. A bigram model is based on conditional probabilities, where the likelihood of each word in a phrase is assumed to depend on only the immediately previous word. The likelihood of a whole phrase is the product of the conditional probabilities of each of the words in the phrase.

Depending on the language model being used, a phrase may have a set of externally relevant features. These features are the aspects of the phrase that contribute to the context-dependent scores of sibling phrases, according to the definition of the language model. In a trigram model, for example, it is generally the first and last two words. In more elaborate language models, features might include elements such as head word, part of speech tag, constituent category, etc. The degree to which the language model used matches reality, in terms of what features are considered externally relevant, will affect the quality of the output.

Using a forest-based method, only the best internally scoring phrase may be maintained. Other phrases may be pruned, which exponentially reduces the total number of phrases to be considered. That is, the ranking algorithm is able to exploit the independence that exists between most disjunctions in the forest.

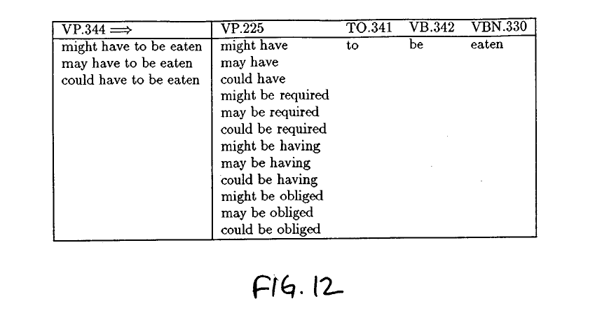

FIG. 12 illustrates a pruning process that may be used with a bigram model. The rule for node VP.344 in the forest shown in FIG. 11A is shown, with the set of phrases corresponding to each of the nodes. If every possible combination of phrases is considered for the sequence of nodes on the right hand side, there are three unique first words: might, may, and could. There is only one unique final word: eaten. Since the first and last words of a phrase are externally relevant features in a bigram model, only the three best scoring phrases (out of the twelve total) need be maintained for node VP.344 (one for each unique first-word and last-word pair). In the bigram model, the other nine phrases will not be ranked higher than the three maintained, regardless of the elements vP.344 may later be combined with. Note that although the internal words of VP.344 are identical, this is not the general case. The most likely internal phrase depends on the context words and may vary accordingly.

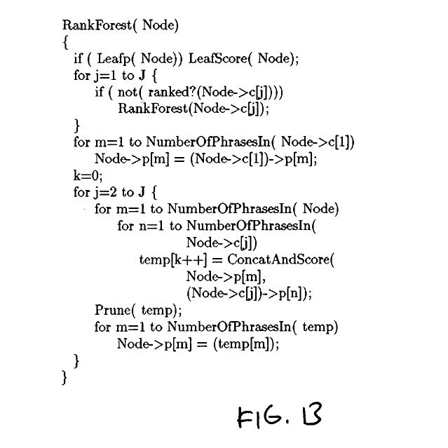

Pseudocode for a ranking algorithm that may be used is shown in FIG. 13. “Node” may be a record including at least an array of child nodes, “Node->c[1 . . . N],” and best-ranked phrases “Node->p[1 . . . M].” The function ConcatAndScore concatenates two strings together, and computes a new score. The function Prune causes the best phrase for each set of features values to be maintained.

The core loop in the algorithm considers the children of the node one at a time, concatenating and scoring the phrases of the first two children and pruning the results before considering the phrases of the third child, and concatenating them with the intermediate results from the first two nodes, etc.

The complexity of the algorithm illustrated by the pseudocode of FIG. 13 is dominated by the number of phrases associated with a node rather than the number of rules used to represent the forest or the number of nodes on the right hand side of a node rule.

More specifically, because of the pruning, it depends on the number of features associated with the language model, and the average number of unique combinations of feature values. If f is the number of features, v the average number of unique values seen in a node for each feature, and N the number of N best phrases being maintained for each unique set of feature values (but not a cap on the number of phrases), then the algorithm has the complexity of O((vN)^{2f}) (assuming that children of AND nodes are concatenated in pairs). Note that f=2 for the bigram model and f=4 for the trigram model.

In comparison, prior art systems using a lattice structure rather than a forest structure may have a complexity O((vN)^{l}), where l is approximately the length of the longest sentence in the lattice. That is, the current system may provide an exponential reduction in complexity while providing an optimal solution. Generators using a capped N-best heuristic search algorithm have lower complexity O(vNl), but generally fail to find optimal solutions to longer sentences.

Testing

It can be difficult to quantify the results of sentence generation. One reason is that there may be more than one “correct” output for a given input. For example, FIG. 1B illustrates a simple situation in which two different outputs are correct.

The sentence generator described herein was evaluated using a portion of the Penn Treebank as a test set. The Penn Treebank offers a number of advantages as a test set. It contains real-world sentences, it is large, and it can be assumed to exhibit a very broad array of syntactic phenomena. Additionally, it acts as a standard for linguistic representation.

To perform the test, inputs to the sentence generator were automatically constructed from the Treebank annotation and then regenerated by the system. The output was then compared to the original sentence. For mostly specified inputs, coverage and accuracy ranged from 76% and 84%, with exact matches generated 34% of the time. For minimally specified inputs, coverage and accuracy ranged from 80% and 48%.

A number of implementations have been described. Nevertheless, it will be understood that various modifications may be made without departing from the spirit and scope of the invention. For example, the form and symbols used in the input may be different. Different labeling schemes may be used. Different methods of weighting may be used. Different statistical rankers may be used. Process steps may be performed in the order given, or in a different order. Accordingly, other embodiments are within the scope of the following claims.

What is claimed is:

1. A method, comprising:
receiving an input representing one or more ideas to be expressed;
transforming at least a portion of the input using a recasting rule;
transforming at least a portion of the input using a morph rule;
producing a plurality of possible expressions for the one or more ideas based on the transforming;
ranking at least some of the one or more possible expressions; and
producing an output sentence expressing the one or more ideas based on the ranking.

2. The method of claim 1, wherein the input includes one or more labeled feature-values.

3. The method of claim 2, wherein the one or more labeled feature-values includes a labeled feature-value having a feature type chosen from the group consisting of a relation and a property.

4. The method of claim 1, further including adding information to the input using a filling rule.

5. The method of claim 1, further including transforming at least a portion of the input using an ordering rule.

6. A system, comprising:
a symbolic generator to receive input representing one or more ideas to be expressed, the symbolic generator to process the input according to mapping rules including one or more recasting rules and one or more morph rules, the symbolic generator to produce a plurality of possible expressions based on the processing; and
a statistical ranker to determine the best choice of the plurality of possible expressions.

7. The system of claim 6, wherein the symbolic generator is further to process the input according to one or more ordering rules.

8. The system of claim 6, wherein the symbolic generator is further to process the input according to one or more morph rules.

9. The system of claim 6, wherein the symbolic generator is further to access a knowledge base.

10. The system of claim 9, wherein the knowledge base includes a lexicon.

11. The system of claim 10, wherein the lexicon is an application-specific lexicon.

12. The system of claim 10, wherein the lexicon is a closed lexicon.

13. The system of claim 6, wherein the symbolic generator is to process not fully specified inputs.

14. The system of claim 6, wherein the symbolic generator is to process inputs including one or more labeled feature-values.

15. The system of claim 6, wherein the symbolic generator is to assign a weight to a possible choice.

16. The system of claim 15, wherein the statistical ranker is to use the weight determine the best choice of the plurality of possible expressions.

17. The system of claim 6, wherein a weighting factor may be assigned to one or more portions of the input, and wherein the statistical ranker is to use the weighting factor to determine the best choice of the plurality of possible expressions.

18. The system of claim 6, wherein the symbolic generator is to process input having a plurality of nesting levels including a top nesting level and one or more lower nesting levels.

19. The system of claim 18, wherein the symbolic generator is to process input having meta OR nodes at a lower nesting level.

20. The system of claim 6, wherein the symbolic generator is to process input having an instance relation with compound values.

21. The system of claim 6, wherein the symbolic generator is to process input including a template relation.

22. An apparatus comprising:
means for transforming a portion of an input including a relation into a new portion including a different relation;
means for adding an additional portion to the input;
means for transforming a second portion of the input to produce a morphologically inflected portion;
means for ordering portions of the input; and
means for producing a plurality of possible expressions based on the input.

23. The apparatus of claim 22, further comprising means for accessing at least one of a lexicon and a dictionary.

24. The apparatus of claim 22, wherein the means for transforming a portion of an input including a relation into a new portion including a different relation comprises one or more recasting rules.

25. The apparatus of claim 22, wherein the means for adding the additional portion to the input comprises one or more filling rules.

26. The apparatus of claim 22, wherein the means for transforming the second portion of the input to produce the morphologically inflected portion comprises one or more morph rules.

27. The apparatus of claim 22, wherein the means for ordering portions of the input comprises one or more ordering rules.

28. The apparatus of claim 22, further including means for preserving one or more ambiguities.

29. The apparatus of claim 22, further comprising:
means for statistically ranking at least some of the plurality of possible expressions; and
means for producing an output sentence based on the statistical ranking.

30. An article comprising a machine-readable medium storing instructions operable to cause one or more machines to perform operations comprising:
receiving an input representing one or more ideas to be expressed;
transforming at least a portion of the input using a recasting rule;
transforming at least a portion of the input using a morph rule;
producing a plurality of possible expressions for the one or more ideas based on the transforming;
ranking at least some of the one or more possible expressions; and
producing an output sentence expressing the one or more ideas based on the ranking.

31. The article of claim 30, wherein the input includes one or more labeled feature-values.

32. The article of claim 31, wherein the one or more labeled feature-values includes a labeled feature-value having a feature type chosen from the group consisting of a relation and a property.

33. The article of claim 30, wherein the operations further include adding information to the input using a filling rule.

34. The article of claim 30, wherein the operations further include transforming at least a portion of the input using an ordering rule.
